(19) United States
(12) Patent Application Publication
(10) Pub. No.: US 2013/0262214 A1
(43) Pub. Date: Oct. 3, 2013

(54) DECISIONING SYSTEM BASED ON ACCOUNT BEHAVIOR AT INDIVIDUAL MERCHANT

(71) Applicants: Garrett C. Baird, Philadelphia, PA (US); David Hickey, Long Valley, NJ (US)

(72) Inventors: Garrett C. Baird, Philadelphia, PA (US); David Hickey, Long Valley, NJ (US)

(73) Assignee: BOON CORPORATION, Long Valley, NJ (US)

(21) Appl. No.: 13/438,629

(22) Filed: Apr. 3, 2012

(51) Int. Cl. G06Q 30/02

(52) U.S. Cl. 705/14.33

(57) ABSTRACT

A method and system for administering rewards is disclosed. Administering rewards comprises processing transaction data received from a transaction processor, the transaction data identifying a payment amount to be made from an account holder to a merchant; determining, at an administration processor, a reward amount of the payment amount based on an account holder profile, designee profile and a merchant profile; initiating a debit of the reward amount from an account associated with the payment to be made to the merchant; and initiating a credit of at least a portion of the reward amount to at least one different account designated by the account holder (or billing/debiting the merchant in a separate transaction).

### FIELD OF THE INVENTION

The present invention relates to administration of rewards, including credit, debit, prepaid accounts, rebate and discount programs. Specifically, the present invention is directed to providing administration of rewards, which may be in the form of rebates or discounts for use with credit, debit, and prepaid account network transactions on a per account holder per merchant basis.

### BACKGROUND OF THE INVENTION

There are numerous programs for administering points, cash back, coupons, vouchers, gift cards, or discount programs, which are tied to various payment reward or rebate programs. Cash back or rebate reward programs, for example, typically operate as across the board programs with reward program administrators setting global rates for all account holders. Many cash back or discount reward programs operate at a merchant category level as well. Certain reward programs offer merchant rebates per account holder. However, as these rewards are unique to each individual merchant and unique to each individual account holder that transacts with each individual merchant, a significant amount of processing is required for the rebates or rewards to be administered. Rebates or rewards may also be delivered to recipients other than the account holder in the form of a gift card, cash rebate or discount. However, the process described above renders the administration of rebates or rewards very paperwork intensive and inefficient.

### BRIEF SUMMARY OF THE INVENTION

In an embodiment, a method for administering rewards is disclosed. The method comprises processing transaction data received from a transaction processor, the transaction data identifying a payment amount to be made from an account holder to the merchant; determining, at an administration processor, a reward amount of the payment amount based on an account holder profile and a merchant profile; initiating a debit of the reward amount from an account associated with the payment amount to be made to the merchant; and initiating a credit of at least a portion of the reward amount to at least one different account designated by the account holder.

In yet another embodiment, processing transaction data comprises validating an account number associated with the account holder; and validating a merchant identification number associated with a participating merchant. Validating an account number by the administration processor comprises determining whether the account number matches an account profile in a user database; retrieving historical attribute data associated with a matched account profile in response to determining that the account number matches an account profile; and creating a new account, associated with the account number, in the user database in response to determining that the account number does not match an account profile. The historical attribute data may comprise 1) previous spending amounts of transactions between the account holder and the merchant, 2) the previous number of transactions between the account holder and the merchant, 3) designation of a designee or designees as a reward recipient by the account holder, 4) the spending by account holders collectively when designating a given designee as a reward recipient, 5) the number of visits to merchant by account holders collectively when designating a given designee as a reward recipient, 6) designation of a preferred merchant or merchants by a designee, 7) designation of a preferred merchant or merchants by the account holder. Validating a merchant identification number comprises determining whether the merchant identification number matches a merchant profile, stored in a merchant database, indicating that the merchant is a participant of a rewards program.

In yet another embodiment, determining a reward amount of the transaction amount comprises adding the transaction amount to a spending history of the account holder in the merchant profile to generate a total transaction amount; determining whether the total transaction amount exceeds a merchant reward threshold of the merchant profile; applying a basic rebate rate or discount rate as the reward amount in response to determining that the total transaction amount is below the merchant rebate or discount threshold; and applying a status level rebate or discount as the reward amount in response to determining that the total transaction amount exceeds the merchant rebate or discount threshold. The determination may additionally also factor in the aforementioned historical attribute data.

In a further embodiment, the reward amount is a discount amount minus processing fees. Initiating a debit of the reward amount from an account associated with the payment amount to be made to the merchant comprises initiating a debit of the discount amount from the payment amount, and initiating a debit of the processing fees from the payment amount. The reward amount could also be billed and debited from the merchant in a separate transaction by the system, which may refund some or all of the initial payment transaction's interchange fee (the fee paid to the account issuing bank by the merchant).

In a further embodiment, initiating a credit of at least a portion of the reward amount to at least one account designated by the account holder comprises determining whether a distribution profile associated with the account holder is stored at a designee database; and initiating a credit of at least a portion of the reward amount to at least one designee of the distribution profile. The distribution profile lists at least one designee chosen by the account holder for receiving at least a portion of the reward amount, each designee associated with a percentage representing the percentage of the at least a portion of the reward amount that the respective designee will receive. The at least one designee may be at least one charity, person or account listed in the distribution profile, wherein the at least one charity is selected by the account holder to receive charitable contributions from the reward amount.

In an embodiment, an administration system is disclosed. A data processor processes transaction data received from a transaction processor, the transaction data identifying a payment amount to be made from an account holder to a merchant. A decision processor determines a reward amount of the payment amount based on an account holder profile and a merchant profile. A transaction processor initiates a debit of the reward amount from an account associated with the payment amount to be made to the merchant and initiates a credit of at least a portion of the reward amount to at least one different account designated by the account holder. The reward amount may also be billed and debited from the merchant in a separate transaction by the system, which may refund some or all of the initial payment transaction's interchange fee (the fee paid to the account issuing bank by the merchant).

In a further embodiment, the data processor is further configured to validate an account number associated with the account holder and validate a merchant identification number associated with the merchant. The administration system may further comprise a user database storing a plurality of account, merchant, and rebate recipient profiles. The data processor may be further configured to determine whether the account number matches one of the plurality of account profiles in the user database, retrieve historical attribute data associated with a matched account profile, and create a new account associated with the account number in the user database if the account number does not match any of the plurality of account profiles. The historical attribute data comprises 1) previous spending amounts of transactions between the account holder and the merchant, 2) the previous number of transactions between the account holder and the merchant, 3) designation of a designee or designees as a reward recipient by the account holder, 4) the spending by account holders collectively when designating a given designee as a reward recipient, 5) the number of visits to merchant by account holders collectively when designating a given designee as a reward recipient, 6) designation of a preferred merchant or merchants by a designee, 7) designation of a preferred merchant or merchants by the account holder. The administration system further comprises a merchant database storing a plurality of merchant profiles. The data processor may be further configured to determine whether the merchant identification number matches one of the plurality of merchant files to indicate that the merchant is a participant of a rewards program.

In a further embodiment, the decision processor is further configured to add the transaction amount to a spending history of the account holder in the merchant profile to generate a total transaction amount, determine whether the total transaction amount exceeds a merchant rebate or discount threshold of the merchant profile, apply a basic rebate or discount rate as the reward amount if the total transaction amount is below the merchant rebate or discount threshold, and apply a status level rebate or discount as the reward amount if the total transaction amount exceeds the merchant rebate or discount threshold. The decision processor may further factor in the aforementioned historical attribute data discussed above.

In a further embodiment, the reward amount is a discount amount minus processing fees. The transaction processor is further configured to initiate a debit of the discount amount from the payment amount, and initiate a debit of the processing fees from the payment amount. The administration system may further comprise a designee database storing a plurality of distribution profiles each associated with an account holder. The transaction processor may be further configured to search for a distribution profile associated with the account holder, and initiate a credit of at least a portion of the reward amount to at least one designee of the distribution profile. The distribution profile lists at least one designee chosen by the account holder for receiving at least a portion of the reward amount, each designee associated with a percentage representing the percentage of the at least a portion of the reward amount that the respective designee will receive. The designee may be at least one charity listed in the distribution profile, wherein the at least one charity is selected by the account holder to receive charitable contributions from the reward amount. A designee can also be an individual with a bank account to whom the reward amount could also be distributed.

In an embodiment, a computer readable medium encoded with computer program instructions for rewards administration is disclosed. The computer program instructions when executed by a processor, causes the processor to perform the steps comprising processing transaction data received from a transaction processor, the transaction data identifying a payment amount to be made from an account holder to the merchant; determining, at an administration processor, a reward amount of the payment amount based on an account holder profile, rebate recipient profile and a merchant profile; initiating a debit of the reward amount from an account associated with the payment amount to be made to the merchant; and initiating a credit of at least a portion of the reward amount to at least one different account designated by the account holder. The reward amount may also be billed and debited from the merchant in a separate transaction by the system, which may refund some or all of the initial payment transaction's interchange fee (the fee paid to the account issuing bank by the merchant).

In a further embodiment, the computer program instructions causing the processor to process transaction data received from the transaction processor, further causes the processor to perform the steps of validating an account number associated with the account holder and validating a merchant identification number associated with the merchant. The computer program instructions causing the processor to validate an account number associated with the account holder, further causes the processor to perform the steps of determining whether the account number matches an account profile in a user database; retrieving historical attribute data associated with a matched account profile in response to determining that the account number matches an account profile; and creating a new account, associated with the account number, in the user database in response to determining that the account number does not match an account profile. The historical attribute data comprises 1) previous spending amounts of transactions between the account holder and the merchant, 2) the previous number of transactions between the account holder and the merchant, 3) designation of a designee or designees as a reward recipient by the account holder, 4) the spending by account holders collectively when designating a given designee as a reward recipient, 5) the number of visits to merchant by account holders collectively when designating a given designee as a reward recipient, 6) designation of a preferred merchant or merchants by a designee, 7) designation of a preferred merchant or merchants by the account holder. The computer program instructions causing the processor to perform the step of validating a merchant identification number, further causes the processor to perform the step of determining whether the merchant identification number matches a merchant profile, stored in a merchant database, indicating that the merchant is a participant of a rewards program.

In a further embodiment, the computer program instructions causing the processor to perform the step of determining a reward amount of the payment amount, further causes the processor to perform the steps of adding the transaction amount to a spending history of the account holder in the merchant profile to generate a total transaction amount; determining whether the total transaction amount exceeds a merchant rebate or discount threshold of the merchant profile; applying a basic rebate or discount rate as the rebate or discount amount in response to determining that the total transaction amount does not exceed the merchant rebate or discount threshold; and applying a status level rebate or discount as the reward amount in response to determining that the total transaction amount exceeds the merchant rebate or discount threshold. The computer program may further factor in the aforementioned historical attribute data discussed above.

In a further embodiment, the reward amount is a discount amount minus processing fees. The computer program instructions causing the processor to perform the step of initiating a debit of the reward amount from an account associated with the payment to be made to the merchant, further causes the processor to perform the steps of initiating a debit of the discount amount from the payment amount and initiating a debit of the processing fees from the payment amount. The reward amount may also be billed and debited from the merchant in a separate transaction by the system, which may refund some or all of the initial payment transaction's interchange fee (the fee paid to the account issuing bank by the merchant). The computer program instructions causing the processor to perform the step of initiating a credit of at least a portion of the reward amount to at least one account designated by the account holder, further causes the processor to perform the steps of determining whether a distribution profile associated with the account holder is stored at a designee database; and initiating a credit of at least a portion of the reward amount to at least one designee of the distribution profile. The distribution profile lists at least one designee chosen by the account holder for receiving at least a portion of the reward amount, each designee associated with a percentage representing the percentage of the at least a portion of the reward amount that the respective designee will receive. The at least one designee may be at least one charity, person or account listed in the distribution profile, wherein the at least one charity is selected by the account holder to receive charitable contributions from the reward amount.

### BRIEF DESCRIPTION OF THE DRAWINGS

FIG. 1 depicts a system facilitating rewards administration, in accordance with an embodiment of the present invention.

FIG. 2 depicts a system facilitating the administration of rewards in accordance with an embodiment of the present invention.

FIG. 3 illustrates a method for administering rewards in accordance with an embodiment of the present invention.

FIG. 4 illustrates a flow chart depicting receipt and processing of transaction data by a program administrator, in accordance with an embodiment of the present invention.

FIG. 5 illustrates a flow chart depicting account number validation of an account holder, in accordance with an embodiment of the present invention.

FIG. 6 illustrates a flow chart depicting validation of a merchant, in accordance with an embodiment of the present invention.

FIG. 7 illustrates a flow chart depicting a decisioning process to determine a reward amount, in accordance with an embodiment of the present invention.

FIG. 8 illustrates a flow chart depicting a collection process in accordance with an embodiment of the present invention.

FIG. 9 illustrates a flow chart depicting a distribution process in accordance with an embodiment of the present invention.

FIG. 10 illustrates an administration system in accordance with an embodiment of the present invention.

FIG. 11 illustrates a high-level block diagram of a computing device utilized for administering rewards in accordance with an embodiment of the present invention.

### DETAILED DESCRIPTION

The present invention is directed to a method and system for administering rewards, which may be in the form of, but not limited to, rebates or discounts to consumers. Embodiments of the present invention are described herein to provide an understanding of administering rewards to credit, debit, and/or prepaid accounts through reward programs on a per account holder per merchant basis. Rewards may be defined as including a discount or a rebate. However, rewards may also include cash back rewards, coupons or vouchers, point based rewards, broadened time windows on sale items, preferred status affiliated with particular merchants; pre-selection of items that discounts may be applied to, or a loyalty program where rewards are redeemable for future purchases. Administration of rewards may be carried out in a processor or in a memory or other circuitry/hardware included or associated with a computing system or device. Accordingly, it is understood that embodiments of the present invention described herein may be performed within a computing system or device by using data stored within the computing system or device or any device associated with the computing system or device.

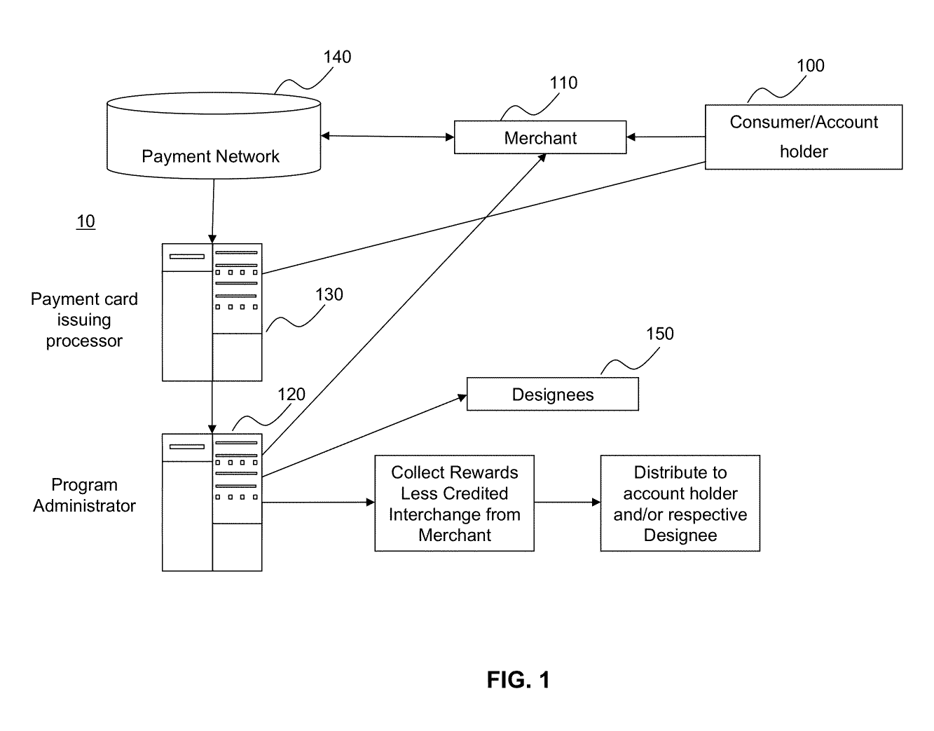

FIG. 1 depicts a system 10 comprising account holders 100, merchants 110, program administrator 120, payment card issuing processor 130, payment network 140, and designees 150. In an embodiment, a consumer or account holder 100 that has registered their account information with the program administrator 120 makes a purchase from a merchant 110 using a credit/debit/prepaid account card, in accordance with an embodiment of the present invention. Program administrator 120 receives the settled transaction data from the payment card issuing processor 130 via any of various payment card issuing processors 130 once settled through payment networks that connect to merchant locations such as Visa®, MasterCard®, Discover®, or American Express®. The settled transaction date is posted to accounts on payment card issuing processor 130 before transmission to program administrator 120. Program administrator 120 collects any applicable rewards, such as rebates or discounts applied from merchant 110. The rewards are then distributed to designees 150, which may be appointed by account holder 100 and/or merchant 110. A portion of the rewards are credited to program administrator 120 as a processing fee.

When an account holder 100 makes a purchase from a merchant 110, transaction data including data identifying the purchase, including account numbers of account holder 100 and merchant 110, a payment amount of the purchase, and date of the purchase is transmitted through payment network 140 for processing by payment card issuing processor 130. Payment card issuing processor 130 (transaction processor 130) is then responsible for transmitting the transaction data to program administrator 120, which will utilize the transaction data to administer rewards from the payment amount to be applied to merchant 110 to any applicable designee of account holder 100.

Program administrator 120 processes the transaction data received from the transaction processor to identify information such as the account numbers of account holder 100 and merchant 110 and the payment amount of the purchase. Using this information and any information from an account holder profile associated with account holder 100 and a merchant profile associated with the payment amount to be made to merchant 110, program administrator 120 is then able to determine a reward amount, which is a portion of the payment amount. The reward amount is then debited by the program administrator 120 from an account associated with the payment amount to be made to merchant 110. The reward amount may also be billed and debited from the merchant in a separate transaction by the system, which may refund some or all of the initial payment transaction's interchange fee (the fee paid to the account issuing bank by the merchant). The account associated with the payment amount to be made to merchant 110 may be any account, such as an account of the account holder, user, or consumer, or a specific merchant designated account. The reward amount is determined based on a discount amount associated with merchant 110, the discount amount representing a predetermined amount to be discounted from the payment amount for purchases made by account holder 100 with merchant 110. The discount amount algorithm combines configuration settings and historical attribute data from the program administrator 120, designees 150, merchant 110, or account holder 100.

Specifically, the discount amount represents the total amount of the payment amount that is apportioned for distribution to designees and payment of various processing or interchange fees to entities facilitating the reward amount. The discount amount=the reward amount+processing/interchange fees. The reward amount is the discount amount minus any applicable processing fees, interchange fees, and/or other fees, and thus the reward amount represents the net amount that is leftover for distribution to designees 150. The processing fees are credited to the program administrator 120. Additional processing fees may also be credited to various interchange or clearinghouses which facilitate the transaction of the reward amount to any designees that have been designated by account holder 100. The designees 150 may be, for example, charitable organizations which account holder 100 would like to contribute to, other people or accounts for which information exists to transfer rewards. Account holder 100, for example, may designate a certain percentage of the reward amount to be transmitted to each charitable organization if there is more than one charitable organization designated.

In another embodiment, the designees are designated by the account holder. The designees may also designate merchants. This may render certain merchants more attractive for purchases by an account holder due the affiliation between the merchant and charitable organization if the account holder would like rewards to flow to that particular charitable organization while also increasing the loyalty to a given merchant by having multiple account holders affiliated with a given designee know that a preferred merchant or merchants has been chosen by that designee.

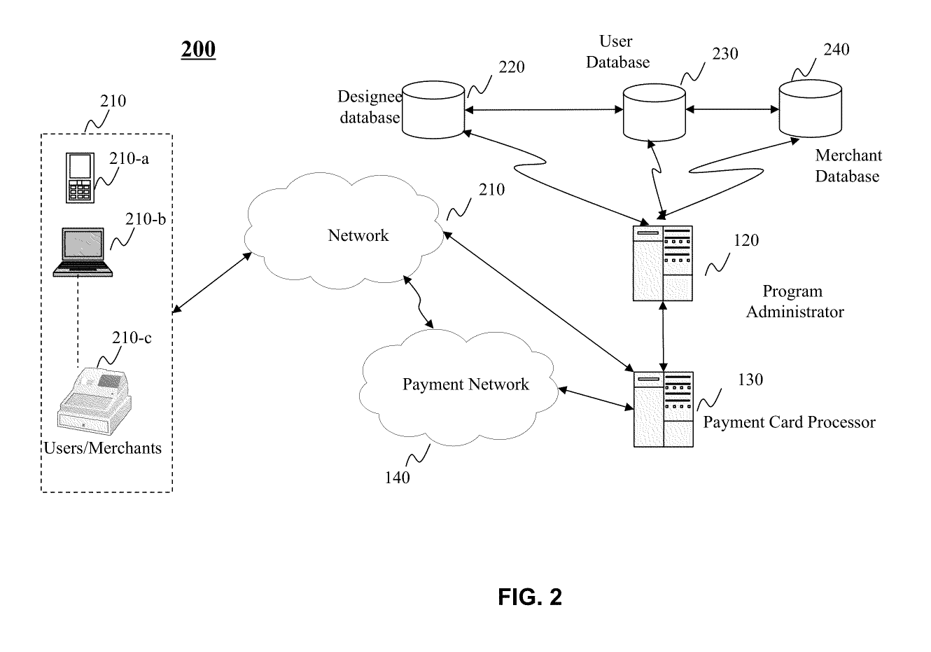

FIG. 2 depicts a system 200 facilitating the administration of rewards in accordance with an embodiment of the present invention. Transaction devices 210 may include devices used by both account holders or consumers, and merchants to facilitate purchases of goods or services. For example, mobile communications device 210-a may be used to make purchases from merchant 210-c through network 210. In an additional example, computing device 210-b may be used to make purchases from merchant 210-c through network 210. When a payment is made, transaction data including data identifying the purchase, including account numbers of an account holder using mobile communications device 210-a or computing device 210-b and merchant 210-c, a payment amount of the purchase, and date of the purchase is transmitted through network 210 to payment network 140 for processing by transaction processor 130. Transaction processor 130 may then transmit the transaction data to the program administrator 120, which will utilize the transaction data to administer rewards from an account associated with the payment to be made to merchant 110 to any applicable designee of account holder 100.

Program administrator 120 processes the transaction data received from the transaction processor to identify information such as the account numbers of the account holder using mobile communications device 210-a or computing device 210-b and merchant 210-c and the payment amount of the purchase. Using this information and additional information from user database 230 and merchant database 240, program administrator 120 is then able to determine a reward amount, which is a portion of the payment amount.

User database 230 stores account profiles or users. For example, user database 230 may store an account profile for an account holder using mobile communications device 210-a or computing device 210-b. The account profile may include historical attributes associated with the user regarding previous spending amounts and previous purchases between the user and the merchant 210-c. If there is no account profile for the account holder, a new account profile may be created. The historical attributes may include information such as: 1) previous spending amounts of transactions between the account holder and the merchant, 2) the previous number of transactions between the account holder and the merchant, 3) designation of a designee or designees as a reward recipient by the account holder, 4) the spending by account holders collectively when designating a given designee as a reward recipient, 5) the number of visits to merchant by account holders collectively when designating a given designee as a reward recipient, 6) designation of a preferred merchant or merchants by a designee, 7) designation of a preferred merchant or merchants by the account holder.

Merchant database 240 stores merchant profiles or merchants. For example, merchant database 240 may store a merchant profile that identifies whether that particular merchant is a participant in a rewards program. Certain information from the transaction data may be added to the merchant profile. For example, the payment amount may be added to a spending history for a particular account holder who makes purchases from the merchant. The total transaction amount is used to assist in determining the reward amount because each account holder will have a merchant rebate or discount threshold associated with the merchant. The aforementioned merchant rebate or discount threshold is predetermined by a merchant and program administrator, and may be set by the program administrator.

The information from the transaction data, as well as the information from the account profile and merchant profile are analyzed by program administrator 120 in order to determine an appropriate reward amount for the payment amount. The reward amount is a discount amount associated with a particular merchant profile minus any processing or interchange fees. The discount amount and processing fees are debited from the payment amount to be paid to the merchant. The reward amount is debited by program administrator 120 from an account associated with the payment amount to be made to merchant 110. The reward amount, may then be credited by program administrator 120 to any designees that have been designated by account holder 100.

Program administrator 120 determines the designees from designee database 220. Designee database 220 stores distribution profiles associated with each account holder. Each distribution profile lists designees and a percentage associated with each designee to indicate what percentage of the reward amount will go to each designee. The distribution profiles further include bank account information to be used in facilitating transfer of funds

The distribution profiles stored in designee database 220 are associated with each account holder. This means that each account holder may access the designee database 220 to specifically define how charitable contributions should be dispensed. Designee database 220, through program administrator 120, facilitates the management of designee reward distributions. For example, an account holder can list charitable organizations, such as the American Red Cross, American Cancer Society, and others. Each charitable organization can be associated with a specific threshold amount to be donated or a specific percentage. The percentage indicates what percentage of the reward amount is dispensed to a particular charity.

Charitable organizations may also designate a preferred merchant or merchants. For those merchants which are designated, they may offer different reward amounts for purchases to those account holders designating those charities. For example, if an account holder purchases from a specific merchant that has been designated by a specific charitable organization, the reward amount that the merchant may be willing to offer a customer may be greater. By way of example, account holder purchases from merchant 110. Charity A may have designated Merchant 110. Under normal circumstances if the account holder designated only Charity B, the reward offered by Merchant 110 would only be 5% of the purchase amount. However, since the account holder has designated the reward to Charity A that chose Merchant 110 among its preferred merchants, Merchant 110 will provide a 10% reward amount to the customer.

Increased reward amounts may also be linked to particular goods sold by a particular merchant. For example, if an account holder purchases a particular type of good designated by a merchant that has been linked to a charitable organization, an opportunity for an increased reward amount credited to that charitable organization is enabled.

Charitable organizations not affiliated with either the rewards program run by program administrator 120 or an affiliated merchant, may also be designated as designees to receive reward amounts. Most unaffiliated charitable organizations are those selected by an account holder or consumer. Upon designation of an unaffiliated charitable organization to receive reward amounts, program administrator 120 generates a message that is then transmitted to the unaffiliated charitable organizations, including information on how to become affiliated and join the rewards program.

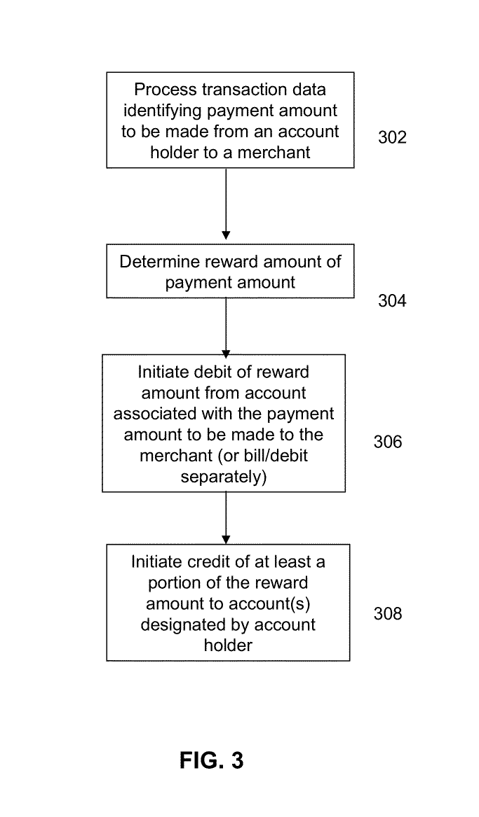

FIG. 3 illustrates a method for administering rewards in accordance with an embodiment of the present invention. At step 302, transaction data is received at a program administrator. The transaction data originates from a transaction processor 130 after a purchase has been made from a merchant from an account holder. This transaction data is then transmitted from transaction processor 130 to program administrator 120.

At step 304, the transaction data is processed. The transaction data may include information such as account numbers of account holder 100 and merchant 110, a payment amount of the purchase, and date of the purchase. Processing of the transaction data by program administrator 120 may include validating the account number of account holder 100 and validating a merchant account number or merchant identification number of the merchant 110. To validate an account number, program administrator 120 determines whether the account number of account holder 100 matches an account profile stored in user database 230. If there is a match, historical attribute data associated with the matched account profile is retrieved. If there is no match, a new account profile is created and associated with the account number of account holder 100. To validate a merchant account number or merchant identification number of merchant 110, program administrator 120 determines whether the merchant account number matches a merchant profiled stored in merchant database 240. If there is a match, this indicates that merchant 110 is a participant in a rewards program administrated by program administrator 120.

At step 306, a reward amount of the payment amount is determined. The reward amount is determined by program administrator 120 by utilizing the transaction data, including payment amount, as well as utilizing the account holder profile from user database 230 and the merchant profile from merchant database 240. The payment amount may be added to a spending history of the account holder in the merchant profile. The payment amount is added to generate a total transaction amount which is compared with a merchant rebate or discount threshold to determine what rebate or discount rate to apply to determine the reward amount.

At step 308, a debit of the reward amount from an account associated with the merchant is initiated. After the reward amount is determined, program administrator 120 initiates a debit of the reward amount from an account associated with the payment amount to be made to the merchant 110. The reward amount is a discount amount associated with a particular merchant profile minus any processing or interchange fees. The discount amount and processing fees are debited from the payment amount to be paid to the merchant. The discount amount is determined based on the merchant profile and is associated with the merchant. The discount amount is the full amount debited from the payment amount. The processing fees may include an interchange fee which will be credited to program administrator 120. The remainder, which is the reward amount, is debited from the account associated with the payment to be made to merchant 110. This reward amount will be used to credit designees of account holder 100.

At step 310, a credit of at least a portion of the reward amount is initiated to at least one account designated by the account holder. Program administrator 120 initiates a credit of at least a portion of the reward amount to at least one account designated by account holder 100. To determine which accounts to initiate a credit to program administrator 120 determines whether a distribution profile associated with account holder 100 is stored at designee database 220. This distribution profile includes a list of designees and a percentage associated with each designee representing a proportion of the portion of the reward amount to be received by each designee. The designees may be, for example, charities that account holder 100 would like to patronize, as well as any accounts associated with the account holder 100. For example, the distribution profile may include a list of charity A, charity B, and charity C, each with an associated percentage of 33.33%. Thus, each of charity A, B, and C will receive 33.33% of the portion of the reward amount. The credit of the at least a portion of the reward amount may be made via automated clearing house (ACH).

Thus, the method and system described herein facilitates administration of reward on a per account holder per merchant basis, taking into account specific past behavior by an account holder with a particular merchant. The method and system described herein also facilitates crediting of rewards in the form of rebates or discounts to designees of the account holder. In the event that program administrator 120 receives transaction data of a transaction between an account holder 100 and a merchant 110 that is not a participant of an award program, program administrator 120 will skip processing of the transaction data. Prior to any transactions taking place, a program administrator may configure merchant profiles stored at merchant database 240 to define reward levels and how they relate to customer behavior attributes. Account profiles stored at user database 230 may similarly be defined by the program administrator.

Program administrator 120 is further configured to generate reports for each merchant, which indicate specific transactions by each account holder and other information regarding transactions and reward programs. The generation of reports by program administrator 120 allows merchants to manage a portfolio of charitable organizations that reward amounts are dispensed to. A feature may optionally be provided that provides for merchants to be able to see information relating to how much is being donated to charitable organizations affiliated with the merchant, and how the reward amounts are linked to specific discounts offered by the merchant. Another optional feature may allow merchants to access a reporting portal to view summary reports or download transaction histories. Customized reports and data feeds may also be provided from the program administrator 120 to merchants.

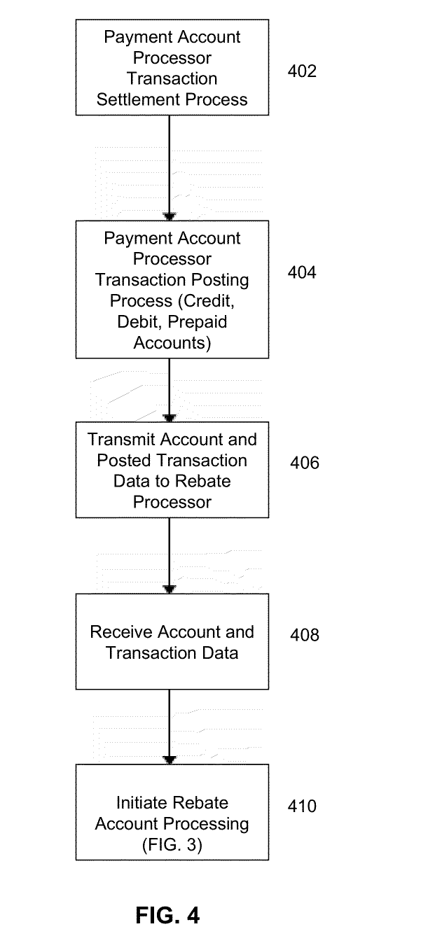

FIG. 4 illustrates a flow chart depicting receipt and processing of transaction data by a program administrator, in accordance with an embodiment of the present invention. At step 402, transaction processor 130 completes a transaction settlement process between an account holder 100 and merchant 110. At step 404, transaction processor 130 initiates a posting process. At step 406, transaction data, including account numbers of account holder 100 and merchant 110, and posted transaction data are all transmitted from transaction processor 130 to program administrator 120. At step 408, program administrator 120 receives the transaction data from payment card processor 130. At step 410, program administrator 120 initiates account processing to determine a reward amount to be furnished to designees of account holder 100 based on the transaction data and other data stored at user database 230, merchant database 240, and designee database 220.

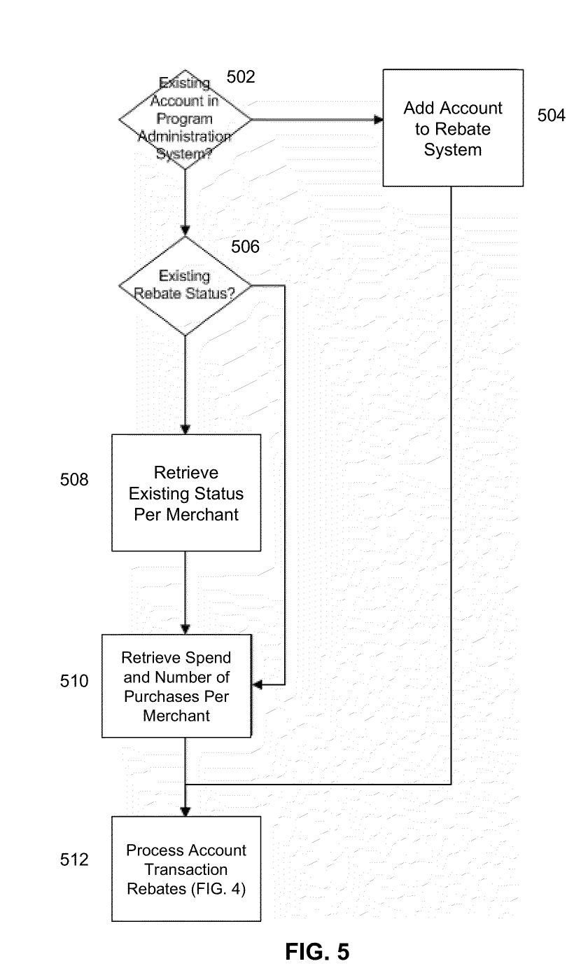

FIG. 5 illustrates a flow chart depicting account number validation of an account holder, in accordance with an embodiment of the present invention. At step 502, program administrator 120 determines whether the account number of account holder 110 matches an existing account profile stored in user database 230. If the account number does not match an existing account profile stored in user database 230, the flow chart proceeds to step 504 to add an account profile associated with the account number. If the account number matches an existing account profile stored in user database 230, the flow chart proceeds to step 506 to determine if an existing rebate or discount status exists for account holder 110. If there is an existing rebate or discount status, the flow chart proceeds to step 508 where the existing rebate or discount status is retrieved from user database 230. A specific rebate or discount status is retrieved based upon whether the account holder has exceeded spend or visit thresholds established by a merchant. Exceeding spend or visit thresholds may, in certain circumstances, qualify the account holder for a higher level discount. The flow chart proceeds to step 510, where spending and number of purchases per merchant for the account holder 110 is retrieved from user database 230. This additionally includes retrieving historical attribute data, as described above, related to the account holder. Alternatively, if at step 506, it is determined that no existing rebate or discount status for account holder 110, the flow chart then also proceeds to step 510. At step 512, rebates associated with account holder 110 are processed.

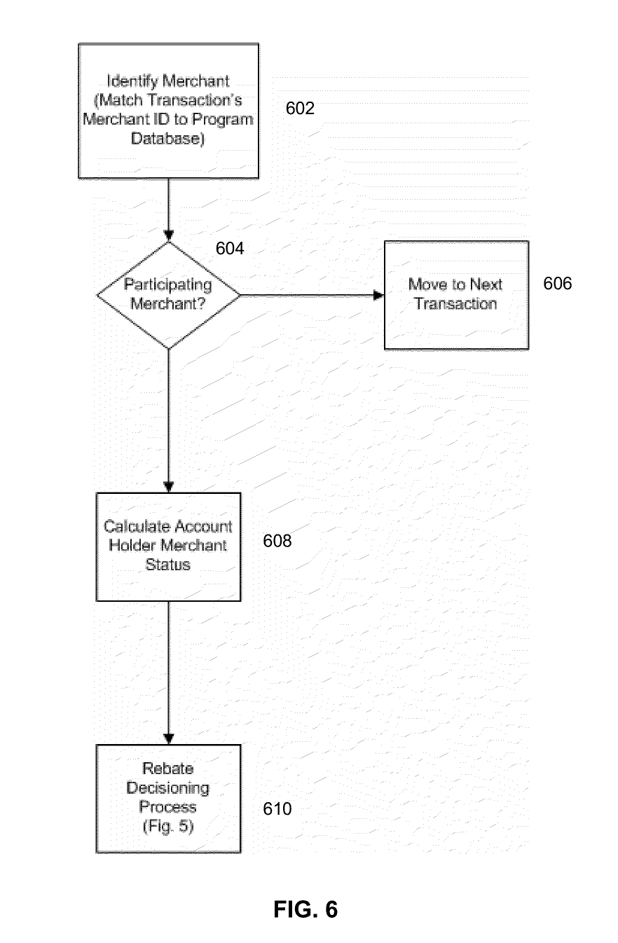

FIG. 6 illustrates a flow chart depicting validation of a merchant, in accordance with an embodiment of the present invention. At step 602, a merchant identification number associated with the transaction data is identified by program administrator 120 by attempting to match the merchant identification number with merchant profiles stored at merchant database 240. At step 604, program administrator 120 determines whether merchant 110 is a participant of a rewards program based on whether the merchant identification number matches any merchant profiles stored at merchant database 240. If merchant 110 is not a participant of a rewards program, program administrator 120 moves to step 606, where program administrator 120 moves on to a next transaction. If merchant 110 is a participant of a rewards program, the flow chart moves to step 608, where program administrator 120 calculates an account holder merchant status. Calculating the account holder merchant status entails checking whether the account holder has exceeded merchant thresholds allowing the account holder to qualify for a higher reward amount. At step 610, program administrator 120 determines the reward amount at the rebate decisioning process.

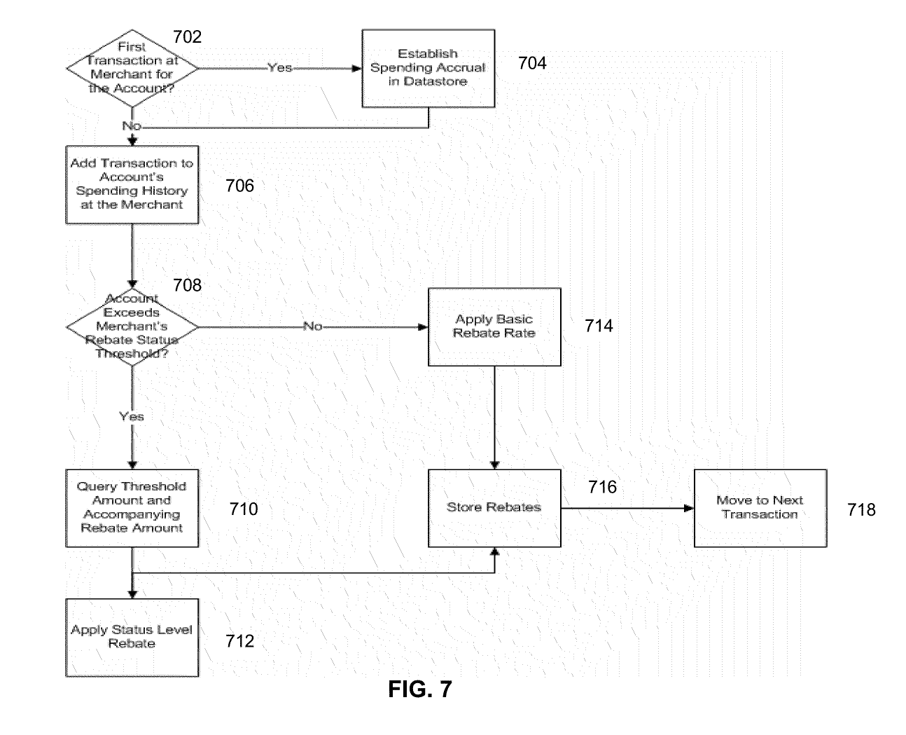

FIG. 7 illustrates a flow chart depicting a decision process to determine a reward amount, in accordance with an embodiment of the present invention. At step 702, program administrator 120 determines whether the transaction between account holder 100 and merchant 110 is a first transaction. If program administrator 120 determines a first transaction, the flow chart proceeds to step 704, where a spending accrual or historical attribute data representing total spending by account holder 100 at merchant 110 is established in the account profile associated with account holder 100 and stored at user database 230. At step 506, either after program administrator 120 determines there is a first transaction, or after step 504, program administrator adds the most recent transaction to the spending history or historical attribute data of the account profile of account holder 100. At step 508, program administrator determines whether a total transaction amount representing a sum of the historical attribute data of payment amounts exceeds merchant 110's status rebate or discount status threshold. The status rebate or discount status threshold is used to determine a percentage that may be applied as a reward amount based on spending. Merchants may set different levels with program administrator 120. At step 510, the threshold amount and accompanying reward amount are queried to determine the actual reward amount based on the historical attribute data and other data such as thresholds. At step 512, a status level rebate or discount is acquired. At step 514, a basic rebate or discount rate is applied. At step 516, the reward amounts are stored. At step 518, program administrator 120 moves to a next transaction.

A status level rebate tracks a status level associated with an account holder or consumer based upon the amount of money or amount of purchases made from the account holder to a particular merchant. For example, if account holder 100 spends over $500 a month at merchant 110, a status level rebate, reward or discount may be applied instead of a basic rebate, reward or discount rate. For example, the basic rebate, reward or discount rate may be 3% of the purchase amount. Thus, amounting to 3% of the purchase amount. However, if it is determined that account holder 100 has spend more than $500 a month over the last two months at merchant 110, the status rebate or discount threshold is determined to have been reached, and a higher status rebate, reward or discount, for example, 5% may be applied to the purchase amount. Thus, the rebate, reward or discount amount would be 5% of the purchase amount instead.

In another embodiment, status level rebates, rewards or discounts may be dependent upon customer or account holder spending with competing merchants. For example, merchant 110 may be able to determine spending habits of account holder 100 with a different competing merchant, and elect to offer a status level rebate, reward or discount to account holder 100 to entice account holder 100 to purchase with merchant 110 instead. The incentive to the customer would be the offer of a greater reward amount that may eventually be passed onto the designees of account holder 100.

In another embodiment, status level rebates, rewards or discounts may be offered to an account holder 100 in the form of an extension or preferred access to a special sale event. For example, merchant 110 has a special sale event offering 20% off all purchases starting on a Wednesday and ending on a Friday. Merchant 110 may elect to pass along the status level rebate, reward or discount in the form of allowing account holder 100 to have access to the special sale event offering 20% off starting early on Tuesday, or extending late, into Saturday. Thus, so long as account holder 100 has met status level thresholds set by merchant 110, account holder 100 may be able to access any of the specific status level rebates, rewards or discounts described above.

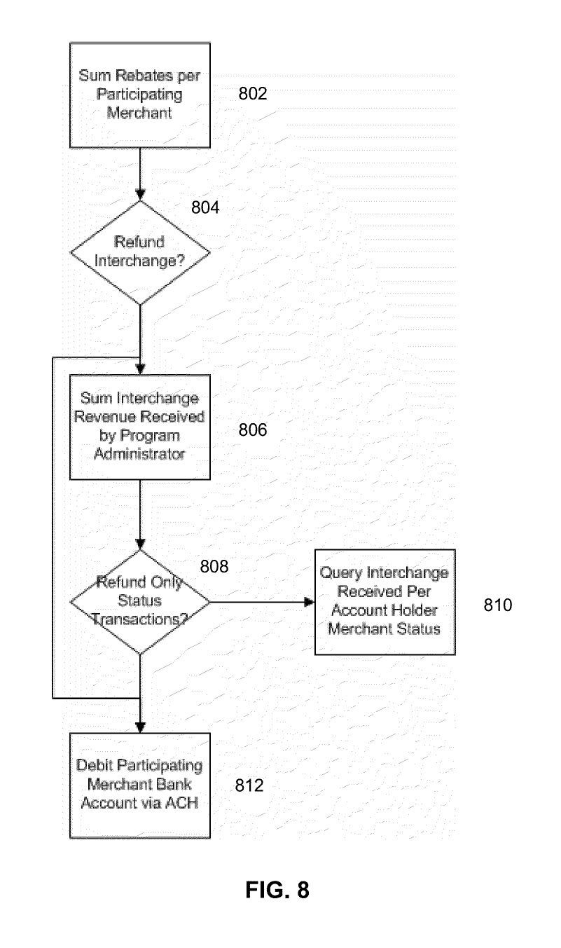

FIG. 8 illustrates a flow chart depicting a collection process in accordance with an embodiment of the present invention. At step 802, discount amounts for each participating merchant are summed. At step 804, program administrator 120 determines whether there is an interchange fee refund. If there is an interchange fee refund, the flow chart proceeds to step 806, where the interchange revenue of all merchants received by program administrator 120 is summed. At step 808, program administrator 120 determines whether only status transactions should be refunded. If status transactions should be refunded, the flow chart proceeds to step 810, to query interchange received per account holder and based on merchant status. The interchange received is delivered by a transaction processor as part of the transaction data. If status transactions should not be refunded, the flow chart proceeds to step 812, to debit reward amounts from a merchant bank or account associated with merchant 110 via ACH. Alternatively, the flow chart may also proceed to step 812 if there is no refund of interchange fees at step 804. Refund of interchange fees is based upon agreements between individual merchants and program administrator 120.

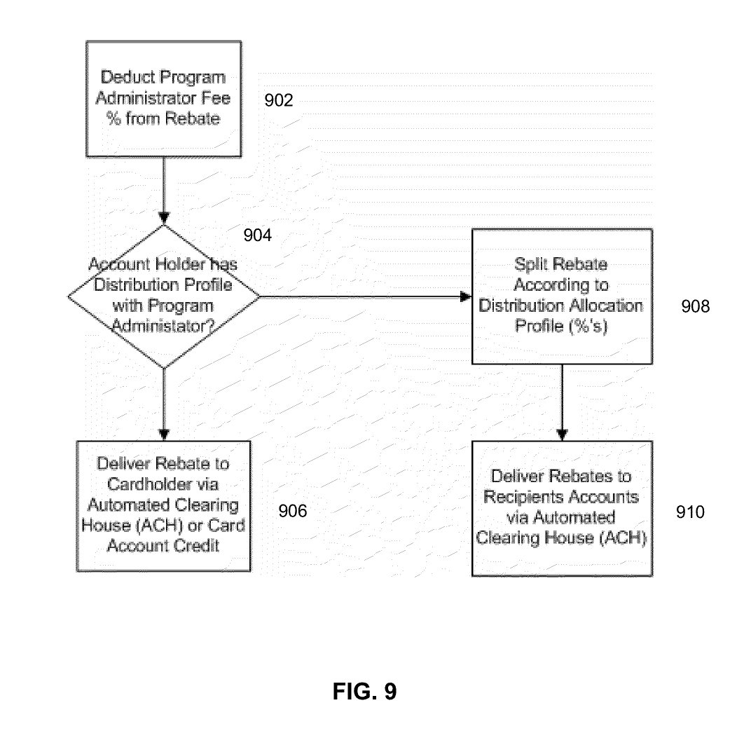

FIG. 9 illustrates a flow chart depicting a rebate or discount distribution process in accordance with an embodiment of the present invention. At step 902, a program administrator fee is deducted from the discount amount associated with a particular merchant. At step 904, program administrator 120 determines whether account holder 100 has an associated designee distribution profile stored in designee database 220. If there is no designee distribution profile, the flow chart proceeds to step 906 where the reward amount is delivered to an account associated with account holder 100. If there is a designee distribution profile, the flow chart proceeds to step 908, where the reward amount is split according to percentages associated with designees in the distribution profile. At step 910, the reward amount is then delivered to the designees.

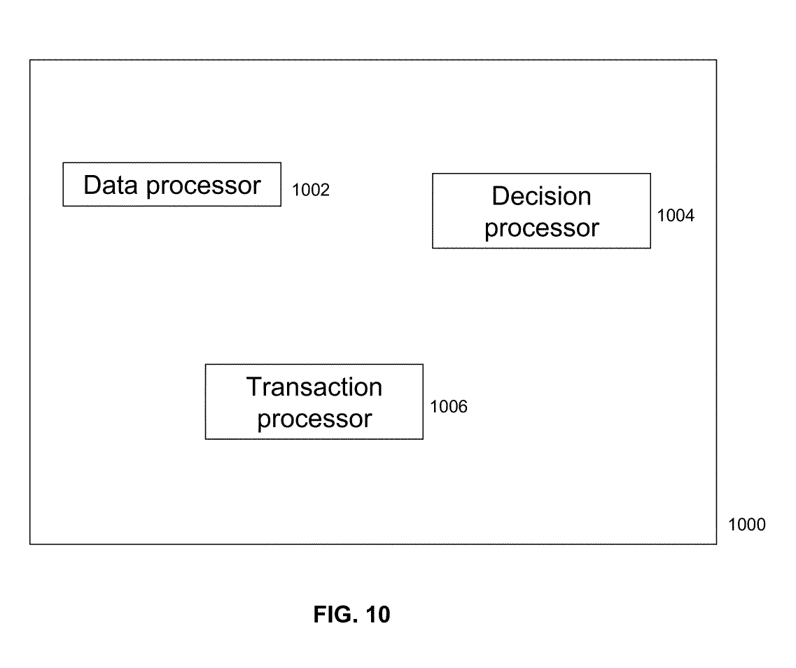

FIG. 10 illustrates an administration system in accordance with an embodiment of the present invention. Administration system 1000 includes data processor 1002, decision processor 1004, and transaction processor 1006. Data processor 1002 processes transaction data received from a transaction processor. Decision processor 1004 determines a reward amount of the payment amount based on an account holder profile and a merchant profile. Transaction processor 1006 initiates a debit of the determined reward amount from an account associated with the payment to be made to the merchant and initiates a credit of at least a portion of the reward amount to at least one different account designated by the account holder.

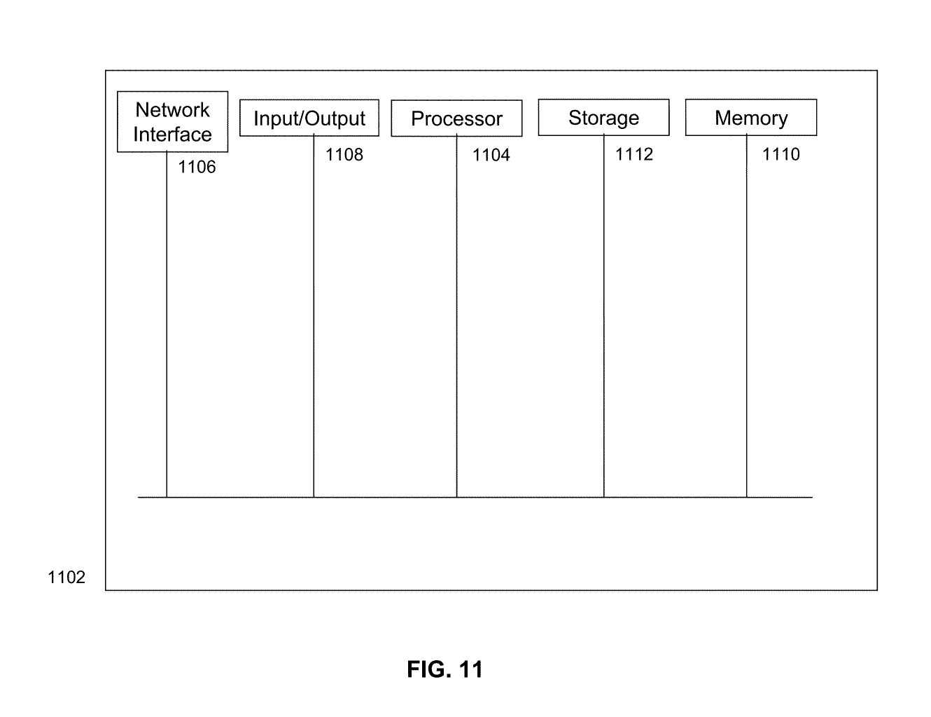

The above described methods for administering rewards, including rebates or discounts, may be implemented on a computing device using well-known processors, memory units, storage devices, software, and other components. A high level block diagram of such a computing device is illustrated in FIG. 11. Computing device 1102 contains a processor 1104 which controls overall operation of computer 1102 by executing computer program instructions, which define such operation. The computer program instructions may be stored in a storage device 1112, or other computer readable medium and loaded into memory 1110 when execution of the computer program instructions is desired. Thus, all method steps described above, including the method steps illustrated in FIG. 3, may be defined by the computer program instructions stored in the memory 1110 and/or storage 1112 and controlled by the processor 1104 executing in the computer program instructions. The computing device 1102 also includes network interfaces 1106 for communicating with other devices via a network. The computer 1102 also includes other input/output devices 1108 that enable user interaction with the computing device 1102 (e.g., display, keyboard, mouse, speakers, buttons, etc.). One skilled in the art will recognize that an implementation of an actual computing device may contain other components as well, and that FIG. 11 is a high level representation of some of the components of such a computing device for illustrative purposes. In addition, computing device 1102 may also perform other functionalities, such as those described above in connection with FIGS. 1 through 10.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by patent law. It is to be understood that the embodiments show and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for administering rewards, comprising:
processing transaction data received from a transaction processor, the transaction data identifying a payment amount to be made from an account holder to a merchant;
determining, at an administration processor, a reward amount of the payment amount based on an account holder profile and a merchant profile;
initiating a debit of the reward amount from an account associated with the payment amount to be made to the merchant; and
initiating a credit of at least a portion of the reward amount to at least one different account designated by the account holder.

2. The method of claim 1, wherein processing transaction data comprises:
validating an account number associated with the account holder; and
validating a merchant identification number associated with the merchant.

3. The method of claim 2, wherein validating an account number comprises:
determining whether the account number matches an account profile in a user database;
retrieving historical attribute data associated with a matched account profile in response to determining that the account number matches an account profile; and
creating a new account, associated with the account number, in the user database in response to determining that the account number does not match an account profile.

4. The method of claim 3, wherein the historical attribute data comprises at least one of: 1) previous spending amounts of transactions between the account holder and the merchant, 2) the previous number of transactions between the account holder and the merchant, 3) designation of a designee or designees as a reward recipient by the account holder, 4) the spending by account holders collectively when designating a given designee as a reward recipient, 5) the number of visits to merchant by account holders collectively when designating a given designee as a reward recipient, 6) designation of a preferred merchant or merchants by a designee, 7) designation of a preferred merchant or merchants by the account holder.

5. The method of claim 2, wherein validating a merchant identification number comprises:
determining whether the merchant identification number matches a merchant profile, stored in a merchant database, indicating that the merchant is a participant of a rewards program.

6. The method of claim 1, wherein determining a reward amount of the payment amount comprises:
adding the payment amount to a spending history of the account holder in the merchant profile to generate a total transaction amount;
determining whether the total transaction amount exceeds a merchant threshold of the merchant profile;
applying a basic rate as the reward amount in response to determining that the total transaction amount exceeds the merchant threshold; and
applying a status level rate as the reward amount in response to determining that the total transaction amount does not exceed the merchant threshold.

7. The method of claim 1, wherein the reward amount is a discount amount minus processing fees.

8. The method of claim 7, wherein initiating a debit of the reward amount from an account associated with the payment amount to be made to the merchant comprises:
initiating a debit of the discount amount from the payment amount; and
initiating a debit of the processing fees from the discount amount.

9. The method of claim 1, wherein initiating a credit of at least a portion of the reward amount to at least one account designated by the account holder comprises:
determining whether a distribution profile associated with the account holder is stored at a designee database; and
initiating a credit of at least a portion of the reward amount to at least one designee of the distribution profile.

10. The method of claim 9, wherein the distribution profile lists at least one designee chosen by the account holder for receiving at least a portion of the reward amount, each designee associated with a percentage representing the percentage of the at least a portion of the reward amount that the respective designee will receive.

11. The method of claim 9, wherein the at least one designee is at least one charity listed in the distribution profile, wherein the at least one charity is selected by the account holder to receive charitable contributions from the reward amount.

12. A rewards administration system, comprising:
a data processor to process transaction data received from a transaction processor, the transaction data identifying a payment amount to be made from an account holder to a merchant;
a decision processor to determine a reward amount of the payment amount based on an account holder profile and a merchant profile;
a transaction processor to initiate a debit of the reward amount from an account associated with the payment amount to be made to the merchant, and to initiate a credit of at least a portion of the reward amount to at least one account designated by the account holder.

13. The system of claim 12, wherein the data processor if further configured to validate an account number associated with the account holder and validate a merchant identification number associated with the merchant.

14. The system of claim 13, further comprising a user database storing a plurality of account profiles; and
wherein the data processor is further configured to determine whether the account number matches one of the plurality of account profiles in the user database, retrieve historical attribute data associated with a matched account profile in, and create a new account, associated with the account number, in the user database if the account number does not match any of the plurality of account profiles.

15. The system of claim 14, wherein the historical attribute data comprises at least one of: 1) previous spending amounts of transactions between the account holder and the merchant, 2) the previous number of transactions between the account holder and the merchant, 3) designation of a designee or designees as a reward recipient by the account holder, 4) the spending by account holders collectively when designating a given designee as a reward recipient, 5) the number of visits to merchant by account holders collectively when designating a given designee as a reward recipient, 6) designation of a preferred merchant or merchants by a designee, 7) designation of a preferred merchant or merchants by the account holder.

16. The system of claim 13, further comprising a merchant database storing a plurality of merchant profiles; and
wherein the data processor is further configured to determine whether the merchant identification number matches one of the plurality of merchant files to indicate that the merchant is a participant of a rewards program.

17. The system of claim 12, wherein the decision processor is further configured to add the payment amount to a spending history of the account holder in the merchant profile to generate a total transaction amount, determine whether the total transaction amount exceeds a merchant threshold of the merchant profile, apply a basic rate as the reward amount if the total transaction amount exceeds the merchant threshold; and apply a status level rate as the reward amount if the total transaction amount does not exceed the merchant threshold.

18. The system of claim 12, wherein the reward amount is a discount amount minus processing fees.

19. The system of claim 18, wherein the transaction processor is further configured to initiate a debit of the discount amount from the payment amount and initiate a debit of the processing fees from the payment amount.

20. The system of claim 12, further comprising:
a designee database storing a plurality of distribution profiles each associated with an account holder; and
wherein the transaction processor is further configured to search for a distribution profile associated with the account holder, and initiate a credit of at least a portion of the reward amount to at least one designee of the distribution profile.

21. The system of claim 20, wherein the distribution profile lists at least one designee chosen by the account holder for receiving at least a portion of the reward amount, each designee associated with a percentage representing the percentage of the at least a portion of the reward amount that the respective designee will receive.

22. The system of claim 21, wherein the at least one designee is at least one charity listed in the distribution profile, wherein the at least one charity is selected by the account holder to receive charitable contributions from the reward amount.

23. A computer readable medium encoded with computer program instructions for reward administration, the computer program instructions when executed by a processor, causing the processor to perform steps comprising:
processing transaction data received from a transaction processor, the transaction data identifying a payment amount to be made from an account holder to a merchant;
determining a reward amount of the payment amount based on an account holder profile and a merchant profile;
initiating a debit of the reward amount from an account associated with the payment amount to be made to the merchant; and
initiating a credit of at least a portion of the reward amount to at least one account designated by the account holder.

24. The computer readable medium of claim 23, wherein the computer program instructions causing the processor to perform the step of processing transaction data received from a transaction processor, further causes the processor to perform the steps of:
validating an account number associated with the account holder; and
validating a merchant identification number associated with the merchant.

25. The computer readable medium of claim 24, wherein the computer program instructions causing the processor to perform the step of validating an account number, further causes the processor to perform the steps of:
determining whether the account number matches an account profile in a user database;
retrieving historical attribute data associated with a matched account profile in response to determining that the account number matches an account profile; and
creating a new account, associated with the account number, in the user database in response to determining that the account number does not match an account profile.

26. The computer readable medium of claim 25, wherein the historical attribute data comprises at least one of: 1) previous spending amounts of transactions between the account holder and the merchant, 2) the previous number of transactions between the account holder and the merchant, 3) designation of a designee or designees as a reward recipient by the account holder, 4) the spending by account holders collectively when designating a given designee as a reward recipient, 5) the number of visits to merchant by account holders collectively when designating a given designee as a reward recipient, 6) designation of a preferred merchant or merchants by a designee, 7) designation of a preferred merchant or merchants by the account holder.

27. The computer readable medium of claim 24, wherein the computer program instructions causing the processor to perform the step of validating a merchant identification number, further causes the processor to perform the step of:
determining whether the merchant identification number matches a merchant profile, stored in a merchant database, indicating that the merchant is a participant of a rewards program.

28. The computer readable medium of claim 23, wherein the computer program instructions causing the processor to perform the step of determining a reward amount of the payment amount, further causes the processor to perform the steps of:
adding the payment amount to a spending history of the account holder in the merchant profile to generate a total transaction amount;
determining whether the total transaction amount exceeds a merchant threshold of the merchant profile;
applying a basic rate as the reward amount in response to determining that the total transaction amount exceeds the merchant threshold; and
applying a status level rate as the reward amount in response to determining that the total transaction amount does not exceed the merchant threshold.

29. The computer readable medium of claim 23, wherein the reward amount is a discount amount minus processing fees.

30. The computer readable medium of claim 23, wherein the computer program instructions causing the processor to perform the step of initiating a debit of the reward amount from an account associated with the payment amount to be made to the merchant, further causes the processor to perform the steps of:
initiating a debit of the discount amount from the payment amount; and
initiating a debit of the processing fees from the payment amount.

31. The computer readable medium of claim 23, wherein the computer program instructions causing the processor to perform the step of initiating a credit of at least a portion of the reward amount to at least one different account designated by the account holder, further causes the processor to perform the steps of:
determining whether a distribution profile associated with the account holder is stored at a designee database; and
initiating a credit of at least a portion of the reward amount to at least one designee of the distribution profile.

32. The computer readable medium of claim 31, wherein the distribution profile lists at least one designee chosen by the account holder for receiving at least a portion of the reward amount, each designee associated with a percentage representing the percentage of the at least a portion of the reward amount that the respective designee will receive.

33. The computer readable medium of claim 31, wherein the at least one designee is at least one charity listed in the distribution profile, wherein the at least one charity is selected by the account holder to receive charitable contributions from the reward amount.

34. A method for administering rewards to charities designated by an account holder, comprising:
processing transaction data received from a payment processor, the transaction data identifying a payment amount to be made from the account holder to a merchant;
determining, at an administration processor, a reward amount of the payment amount based on an account holder profile and a merchant profile;
initiating a debit of the reward amount from an account associated with the payment amount to be made to the merchant; and
initiating a credit of at least a portion of the reward amount to at least one charity designated by the account holder.
